(19) United States
(12) Patent Application Publication
(10) Pub. No.: US 2009/0058098 A1
(43) Pub. Date: Mar. 5, 2009

(54) BACKUP GENERATORS

(76) Inventor: Michael Patrick Flynn, Rancho Santa Fe, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/238,628

(22) Filed: Sep. 26, 2008

Related U.S. Application Data
(63) Continuation-in-part of application No. 12/188,068, filed on Aug. 7, 2008.
(60) Provisional application No. 60/955,587, filed on Aug. 13, 2007.

(51) Int. Cl. H02K 5/04

(52) U.S. Cl. 290/1 R

(57) ABSTRACT

A method for providing backup power for an electronic installation comprising a plurality of electronic units, all operating on standard commercial power, comprising a plurality of backup generators, that are scaleable, modular and redundant, adapted to power one or more of the electronic units in the event standard commercial power is interrupted.

This application claims the benefit of U.S. Provisional Application Ser. No. 60/975,937, filed Sep. 28, 2007, which application is incorporated herein by reference in its entirety. This application is also a continuation-in-part of pending U.S. application Ser. No. 12/188,068, filed Aug. 7, 2008, which claimed the benefit of U.S. Provisional Application Ser. No. 60/955,587, filed Aug. 13, 2007.

### FIELD OF THE INVENTION

This invention is an extension and improvement relating to backup generators for electronic equipment, as described in my earlier filed application Ser. No. 12/188,068 filed Aug. 7, 2008. This includes electronic equipment at cell sites where equipment is located for cellular communication, sites for street lights, signal lights, cable installations, meter pedestals, or the like.

### BACKGROUND OF THE INVENTION

Cell sites, street lights and signal lights, as well as other electronic equipment, are often located in very tight spaces, with little room for additional equipment. This is often because the land, or building space, is leased and expensive, so that only the minimum land or space needed for the equipment is leased.

A cell site is a location where antennas and other electronic equipment are located to provide a cell in a cellular network. Cell sites can be located in urban locations in or on buildings, but are also often located in rural areas, in order to provide cellular service to those areas.

Cell sites usually contain antennas and electronic communications equipment, such as one or more transmitter/receivers, Telco equipment, base transceiver stations, an electrical power source and a backup power source. Often the rural cell sites are not inside of a building and cabinets are used to house the equipment outdoors. The cell sites are usually placed on leased land. Traffic lights and signals also often have limited usable space.

In cell sites, The base transceiver stations (BTS) contain the equipment for transmitting and receiving radio signals and equipment for encrypting and decrypting communications with Base Station Controllers (BSC). Typically, a BTS will have several transceivers in order to serve different frequencies. There are usually a number of base transceiver stations at each cell site.

Power is supplied by standard commercial power provided by a local power company. Present installations have one backup generator in the cell site, in the event that the standard electrical power supply is cut off for any reason. This single backup generator, which may be a fuel cell, batteries, or other means of generating electricity, would supply power to the cell site for a limited period of time, the length of which depends upon the type of backup generator at the site. There is often little or no room for more than one backup generator (gen set).

### SUMMARY OF THE INVENTION

The present invention provides an improved system for backup power in the event that standard commercial power is interrupted at a site. The invention comprises a backup generator (gen set) for each and every key electronic piece of equipment located at the site and/or a “bank” of generators supplying the site power needs. Thus, there would be multiple backup generators at the site and not just a single backup generator, as is now utilized. The use of a plurality of smaller generators to accomplish the power requirements/needs can be a reciprocal, turbine and/or other means of making back up electrical power.

Applicant's backup generators are each contained in a new cabinet, a cabinet can be a stand alone cabinet, shelter and/or indoor rack mounted system. The shelter configuration can also include the ability to mount the modular and/or stacked generators on sliding carriages or the like to minimize the footprint/space requirements.

The cabinet can be a fully integrated unit using, for instance, a propane tank, diesel tank or other fuel supply incorporated into the unit, for fuel to create the backup electrical power. Instead of propane, a unit that uses diesel fuel could be utilized or one using natural gas, or one using a hydrogen fuel cell, or the unit could be connected to a commercial utility providing natural gas and/or both commercial natural gas and on-site fuel storage.

One of the advantages/Options of Applicant's invention is that, instead of there being one backup generator for the entire installation, each and every BTS unit has its own backup generator, so that if regular commercial power is interrupted and/or shut off, each BTS unit, having its own backup power source, would continue to operate. If any of the backup power units also failed, there is a redundancy in having a multiple number of backup power units, so that some of the BTS units would still operate and the cell site can continue to operate.

This is also the case with the use of “banked” generators for powering the entire cell site. In this application the plurality of generators can be used to power the cell site, with additional generators in the “bank” to serve as spares to provide redundancy if one or more of the initial generators does not start up or turns off. The use of Scaleable Modular gen sets also reduces the use of fuel by operating more efficiently, saving the operator money and extending the run time of the gen sets by extending the use of the fuel, as well as reduces the emissions of green house gasses and other pollutants.

Another option is the use of dedicated generators to each electronic cabinet with the use of spare generators to back up each of the dedicated generators and/or the ability with the use of Programmable Logic Control (method for setting hierarchy) to use smaller generators dedicated for each electronic cabinet and/or the cell site, yet based on the power draw needed, the spare generators would come on-line to bolster the power needed for the start up of electronic equipment, cooling equipment (HVAC's and the like) when the power draw is greater then the individual dedicated generators and/or generator bank for normal equipment operation.

### BRIEF DESCRIPTIONS OF THE DRAWINGS

FIG. 1 is a depiction of a Cabinet with a plurality of gen sets, as well as a depiction of sliding cabinet technology in an outdoor cabinet configuration and/or enclosed shelter application;

FIG. 2 is a depiction of a Scaleable Modular stack of gen sets;

FIG. 3 is a depiction of Scaleable dedicated gen sets with additional gen sets for redundancy:

FIG. 4 is a depiction of Scaleable Modular gen sets with dedicated gen sets to each Electronic Cabinet with one or more of the spare gen sets used to bolster power to each of the Cabinets when additional power is required.

FIG. 5 is a depiction of a Scaleable Modular gen set with a bank of gen sets providing power to the cell site with the use of spare/redundant gen sets in a modular/stacked configuration for powering a number of operators in a shared generator application.

FIG. 6 is a depiction of a scaleable/modular gen set application with the gen sets placed in various locations to address cell sites with space constraints where a standard/typical large generator does not fit and/or back up power needs fluctuate with the addition of new operators or reduction of operators at the cell site.

### DETAILED DESCRIPTION OF THE INVENTION

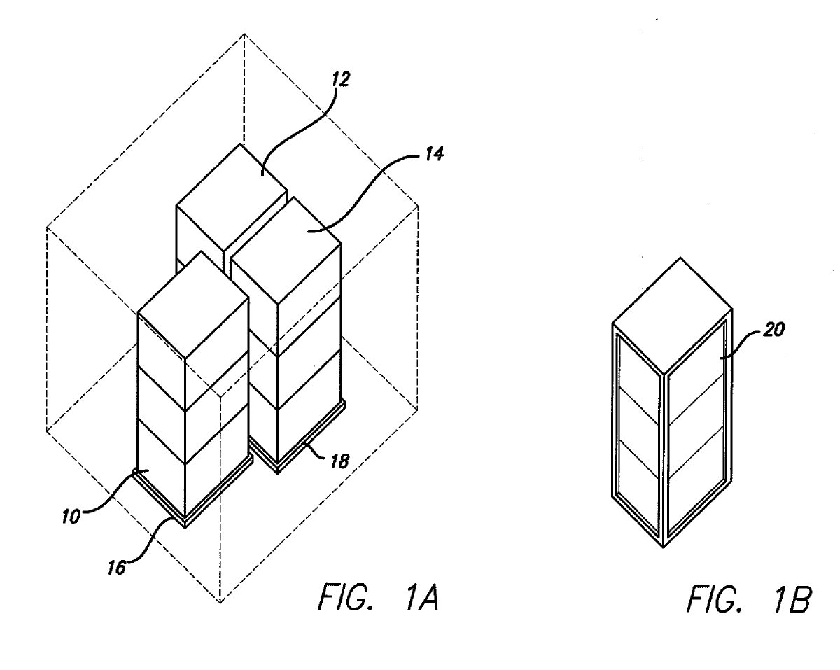

Referring now to the drawings there is shown in FIG. 1, a cabinet is shown with a plurality of stacked modular gen sets for powering individual equipment and/or cell sites in general with all of its equipment.

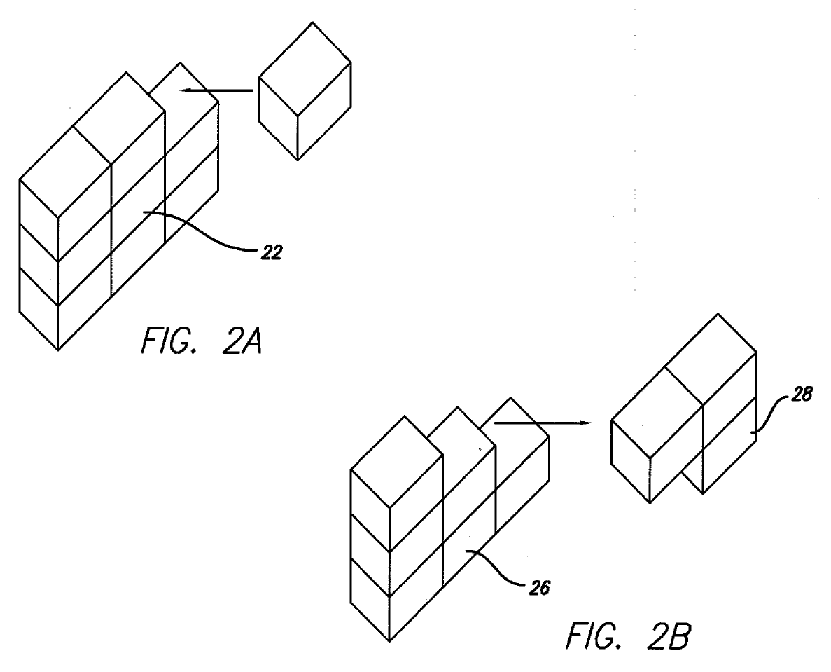

Referring to FIG. 2, there is shown a modular stack of a plurality of gen sets. The modularity of the gen set stack allows expandability or reduction as needed. It also decreases site maintenance cost with the ability to “remove and replace” each of the smaller generators as site power needs increase or decrease, as well as the ability to “remove and replace” non functioning and/or gen sets requiring maintenance. A modular stack can be used to back up a select number of radio cabinets or all of them, which allows carriers to determine emergency backup parameters.

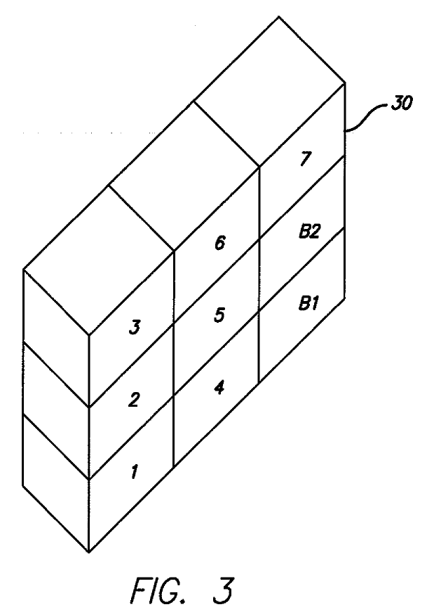

Referring to FIG. 3, there is shown the ability to provide redundancy within the back-up power plant. If one of the dedicated and/or banked gen sets does not start up or fails, the redundant gen sets are used to supply the power lost from the failing of one or more of the dedicated and/or banked gen sets.

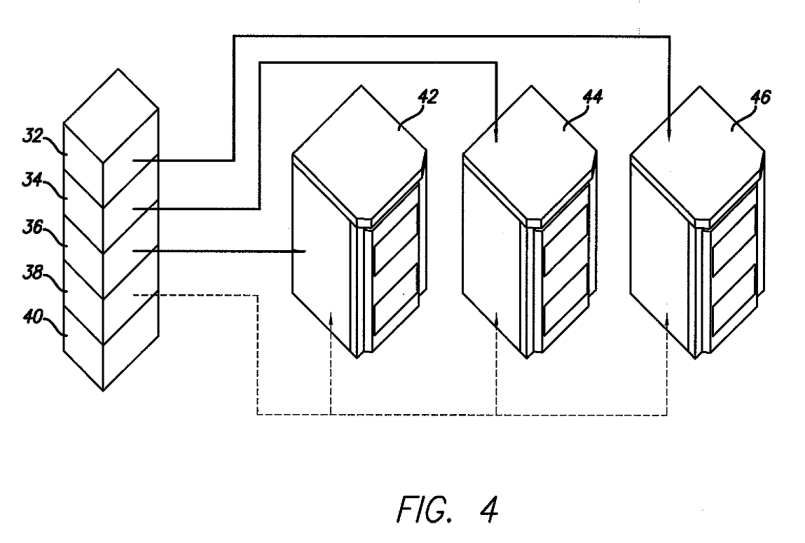

FIG. 4, depicts a set of Scaleable Modular gen sets with each electronic cabinet (equipment) using a dedicated generator with the use of spare/redundant gen sets being used to back up those dedicated gen sets and/or provided the ability to add additional power to each of those dedicated generators as the power output required by the associated electronic equipment increased to initiate start up of the electronic equipment, cooling system or other increase/spike in power required.

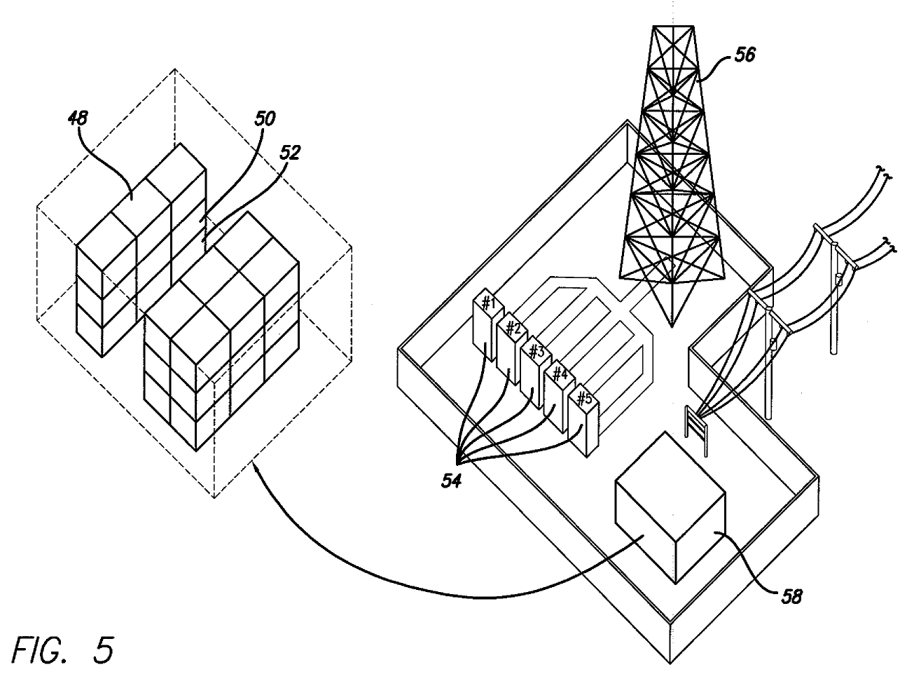

FIG. 5, depicts the use of Scaleable Modular gen sets for the “banking” of generators to provide a cell site with its required power needs. In this use, the banking of gen sets is basically the combining of each of the gen sets into a single power output. This system also includes the use of spare/redundant generators for gen sets that fail to operate, as well as increase power to the banked generators as the cell site power requirements increase and to reduce power when the required cell site needs less power.

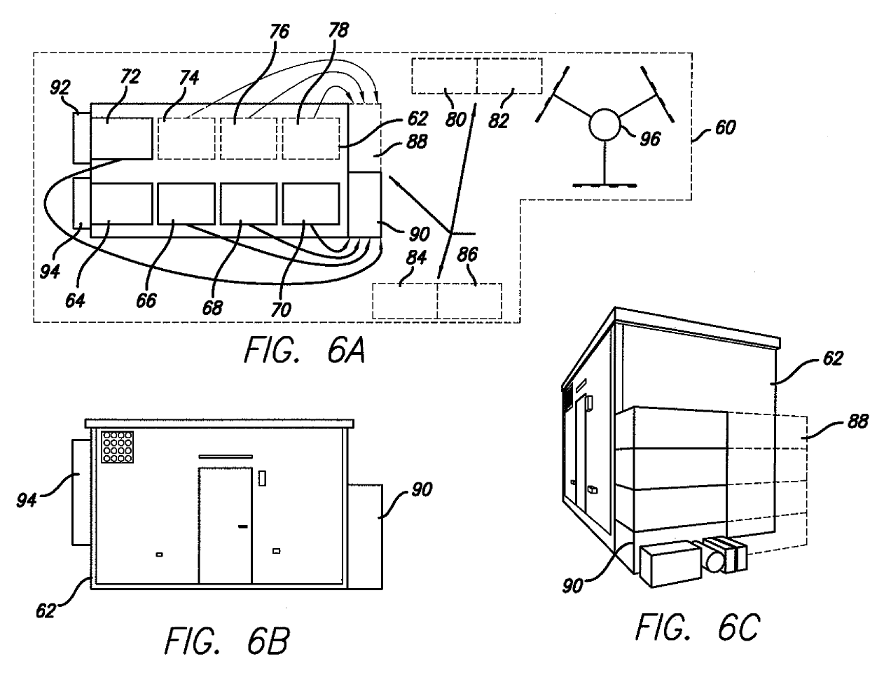

FIG. 6, depicts the Scaleable Modular gen sets configured into a Cabinet configuration with an integrated fuel tank. The Cabinet can be partially sub terrain with the fuel supply in the lower portion of the Cabinet and/or Cabinet Sub Base Plinth if not integrated into the Cabinet. This allows the visual aesthetic impact of the Cabinet (or larger unit, i.e. Shelter) to be reduced with the lowering of the height of the Cabinet, as well as provides secondary fuel containment in addition to the fuel tanks.

### Advantages of Applicant's Gen Set System

1. Limited gen set size and fuel supply assists, if not circumvents, entitlement/jurisdictional/hazardous material/fire issues when placing gen sets on sites.

2. Modularity of the gen set and its fuel supplies to allow “remove and service” availability and fueling replacement by “container/tank” rotation in lieu of a fuel truck or special vendor. The carriers own operations technicians can use special dollies to carry replacement gen sets and fuel replenishment containers/tanks. These smaller fuel supplies may eliminate other jurisdictional issues.

3. The concept of placing Scaleable Modular gen sets for each individual radio cabinet allows redundancy, if one or more of the individual gen sets fail to work. Unlike large gen sets running a number of cabinets, when that gen set fails to initiate, the site completely goes down.

4. The concept of placing Scaleable Modular gen sets “banked” to provide back up power to the cell sites provides a method of being able to most efficiently provide back up power for the cell sites that can be scaled up or down as back up power needs change.

5. The ability to have redundant power with spare gen sets greatly increases the reliability of the back up power plant.

6. The ability to dedicate a smaller gen set to each electronic cabinet with a spare/redundant gen sets used to back up the primary gen sets, as well as provide additional power when needed to the dedicated gen sets provides the most efficient economic and environment operation.

7. The ability to bank a plurality Scaleable Modular gen sets to provide the cell site back up power with the ability to back up the primary banked gen sets for gen sets that fail and/or if power needs increase. The ability to bank a plurality of Scaleable Modular gen sets that provide the cell site back up power with the ability to use turn on or off one of more of the banked gen sets as power needs increase or decrease. It is possible to “daisy chain” (connect in series) gen set modules to provide for the start-up power needed to start up certain equipment, such as air conditioners, and then transition over to normal operation, either power/recharging batteries and/or powering the electronic equipment.

8. The ability of using an integrated Cabinet with an integrated fuel supply module and/or integrated Plinth and/or Sub Base which can be completely and/or partially buried lowering the cabinet height for use in the Public Right of Way and/or Private Property.

9. The use of biodiesel will provide a “green solution”, as well as tax credits, and incentives. Currently there are tax credits for using “green fuels” to, not only offset fuel costs, but also provide tax credits for the actual cost of the gen set. The size of these gen sets also allow for benefits associated with Clean Air Environmental requirements, permitting, etc., associated with gen set placement.

A fire suppression system could optionally be placed into the gen set cabinet, for safety purposes.

There could also be a natural gas feed to the site which could provide a feed to the gen set units in the event of a primary power failure.

The fuel tanks could have “quick disconnect” fittings for easy removal and replacement.

Soundproofing can be provided for the cabinets as well as anti-vibration fittings.

An alarm system could be provided in each gen set cabinet, which also could provide remote monitoring and alerts, as to fuel levels, battery levels, malfunctions, etc.

This system also allows for shelter reconfigurations, which can save the carrier from having for example a 60 kw power source to run a site with two 5 ton HVACs and electronic equipment. If the carrier gets higher capacity equipment in the future (less cabinets needed), and if the carrier wanted to replace the two 5 ton HVACs with a new 2 ton HVAC's, the carrier can decrease the number of Scaleable Modular gen set Cabinets. The modular system maximizes site configuration, fuel use and power requirements, as well as adding and decreasing generator capacity as needed.

Electronic cabinets can be made available with a gen set and/or gen set module integrated into the Cabinet, including fuel supply, and open cabinet space above, allowing the user to place whatever electronic equipment is desired into the cabinet, above the gen set.

The Cabinet could also include the use of an alternative motor/engine to allow for each gen set to “cycle” (the operation of each gen set periodically to maintain oil flow, component operation) without the use of its on site fuel. This method also reduces the use of on site fuel for emergency uses, keeps the generator in optimal operation mode, reduces noise and pollution.

I claim:

1. A method of providing backup power for a wireless cell site comprising a plurality of: transceiver units, comprising a plurality of backup generators adapted to power one or more of the transceiver units in the event normal power is interrupted.

2. The method of providing backup power of claim 1 in which the plurality of backup generators are in a modular stack.

3. The method of providing backup power of claim 1 in which the plurality of backup generators are connected in series.

4. A method for providing backup power for an electronic installation comprising a plurality of electronic units, all operating on standard commercial power, comprising a plurality of backup generators adapted to power one or more of the electronic units in the event standard commercial power is interrupted.

5. The method of providing backup power of claim 4 in which the plurality of backup generators are in a modular stack with dedicated generators to each electronic equipment cabinet, wherein one or more of the backup generators is used to add additional power to each dedicated generator as the power requirements increase for equipment start up, which includes the start up of the electronic equipment and cooling system.

6. The method of providing backup power of claim 4 in which the plurality of backup generators are connected in series and one or more backup generators are used to back up one or more of the series generators, if one or more fails or additional power is required for equipment start up, including electronic equipment and cooling equipment.

7. The method of providing backup power of claim 4 in which each backup generator has its own fuel supply.

8. The method of providing backup power of claim 4 in which a single source of fuel is used to power all of the backup generators.

9. The method of providing backup power of claim 4 in which the source of fuel is a propane tank or a diesel tank.

10. The method of providing backup power of claim 4 in which the single source of fuel is a propane tank, a diesel tank, cable or commercial utility.

11. The method of providing backup power of claim 4 in which the backup generators are adapted to start up air conditioners and then transition over to backup power for batteries and electronic equipment.

12. The method of providing backup power of claim 4 in which two backup generators are connected in series, adapted so that one backup generator charges batteries and the other backup generator operates electronic equipment.

13. The method of providing backup power of claim 12 in which one backup generator will operate if the other backup generator fails to start.

14. The method of providing backup power of claim 4 in which the backup generator is placed in a cabinet, on a slide-out shelf, with open cabinet space above the backup generator.

15. The method of providing backup power of claim 4 in which the plurality of backup generators are adapted to start up equipment needing a power surge to achieve start up.

16. The method of providing backup power of claim 5 comprising using an additional motor or engine to allow the generators to “cycle” during non emergency use.

17. The method of providing back up power of claim 4 comprising generators with a dedicated generator for each electronic cabinet, with a spare generator to back up the primary generator if it fails and provide additional power for start up power as needed.

18. A method for providing a bank of power generators for backing up cell site equipment, comprising spare generators for increased power demands and generator failures.

19. A method of stacking a plurality of backup generators into a cabinet having an integrated fuel containment section, the backup generators being a part of the cabinet, plinth or sub base.
